(19) United States
(12) Patent Application Publication
(10) Pub. No.: US 2004/0267697 A1
(43) Pub. Date: Dec. 30, 2004

(54) File storage network

(76) Inventor: Javad Hamidi, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/875,191

(22) Filed: Jun. 25, 2004

Related U.S. Application Data
(60) Provisional application No. 60/482,015, filed on Jun. 25, 2003.

(51) Int. Cl. G06F 7/00

(52) U.S. Cl. 707/1

(57) ABSTRACT

A computer network is described that efficiently distributes files between client computers. When a network storage file is modified and saved on a first client computer, a first enterprise cloned server receives a change file indicative of changes that have occurred to the network storage file. The change file is then provided to at least one of a client computer proximate the first enterprise cloned server and another enterprise cloned server in communication with the first enterprise cloned server.

### FIELD OF THE INVENTION

This application claims the benefit of U.S. Provisional Application No. 60/482,015 filed Jun. 25, 2003.

This invention relates to network architectures supporting personal computers. More specifically, the invention relates to networks and file storage systems.

### BACKGROUND OF THE INVENTION

Networked personal computers and laptop computers are used in a wide variety of applications. A file server or an array of file servers on the computer network are used to maintain a copy of a set of files accessible by the supported personal computers and laptop computers. In order to protect the data on the file server, it is common to backup the files. When the files are being backed up the network is typically inaccessible. In order to overcome this problem, it is common to provide a redundant server that supports a system for backing up files while the other server is used normally.

Increasingly, laptop and notebook computers are commonly used with such networks. The advantage of such machines is that they are highly portable, allowing people to work when they are not close to their desks. Thus, such a user has access to work files while away from their desk but within contact to a network that has the files they want. If the user wishes to work on a file using a laptop that does not have access to their network then they should transfer the file to their laptop at a time when the laptop is connected to the network. In the event that the user wishes to work remotely on a file that is stored on the network but not stored on their laptop then the user must connect the laptop to the network in order to transfer the file from the network.

It would be beneficial to provide a network architecture that provides users access to the files that they typically work on, even when their computer is unable to connect to an associated network. Additionally, it would be beneficial to provide such a system without increasing the cost of the network or the cost of operating the network.

### SUMMARY OF INVENTION

The invention provides a flexible alternative to conventional file server computer networks. Specifically, a system according to the invention takes advantage of the large memory capacity storage media commonly found on desktop and laptop computers. In a system according to the invention, network storage files that are updated on a first computing device are copied to other computers that have been authorized to have a copy of the network storage file. The system according to the invention need not involve copying the network storage file to a file server when modifications to a network storage file are made.

The invention describes a method of storing an electronic data file comprising:

providing a first computing device other than a file server and comprising a first associated storage medium;

providing a second computing device other than a mirror of the first computing device and comprising a second associated storage medium and in communication with the first computing device;

providing a server;

establishing a first data transfer path from the first computer device to the server;

establishing a second data transfer path from the server to the second computing device;

storing a first file on the first computing device within the first associated storage medium;

storing the first file on the second computing device within the second associated storage device;

modifying the first file on the first computing device to form a new version of the first file;

storing the new version of the first file on the first associated storage medium;

transferring at least a change instruction from the first computing device to the second computing device via the server; and,

automatically storing the new version of the first file within the second associated storage medium by applying the at least a change instruction to the first file.

Additionally, the invention teaches a portable computing device comprising:

a processor for updating a file and storing an updated file associated with the file;

a communication port to supporting electronic communication with an enterprise cloned drive server; and,

a non-volatile storage medium, the non-volatile storage medium for storing files, the non-volatile medium for containing instructions for:

associating an act of storing the updated file with at least a workgroup related to the updated file;

upon successful association of an updated file with a workgroup,

automatically contacting an enterprise cloned drive server via the communication port;

automatically providing data relating to the updated file to the communication port, the data for being stored in a storage medium of a first other computing device and a storage medium of a second other computing device, the first and second other computing devices being other than mirrored to the portable computing device.

### BRIEF DESCRIPTION OF THE DRAWINGS

The invention is now described with reference to the drawings in which:

FIG. 1 is a schematic diagram of a conventional file server network architecture;

FIG. 2 is a schematic diagram of a network architecture supporting a single enterprise cloned server according to the invention;

FIG. 3 is a flowchart describing operations associate with saving a network storage file on a system according to the first embodiment of the invention;

FIG. 4 is a schematic diagram of a network architecture supporting a plurality of enterprise cloned servers according to the invention; and,

FIG. 5 is a flowchart describing operations associate with saving a network storage file on a system according to the second embodiment of the invention.

### DETAILED DESCRIPTION OF THE INVENTION

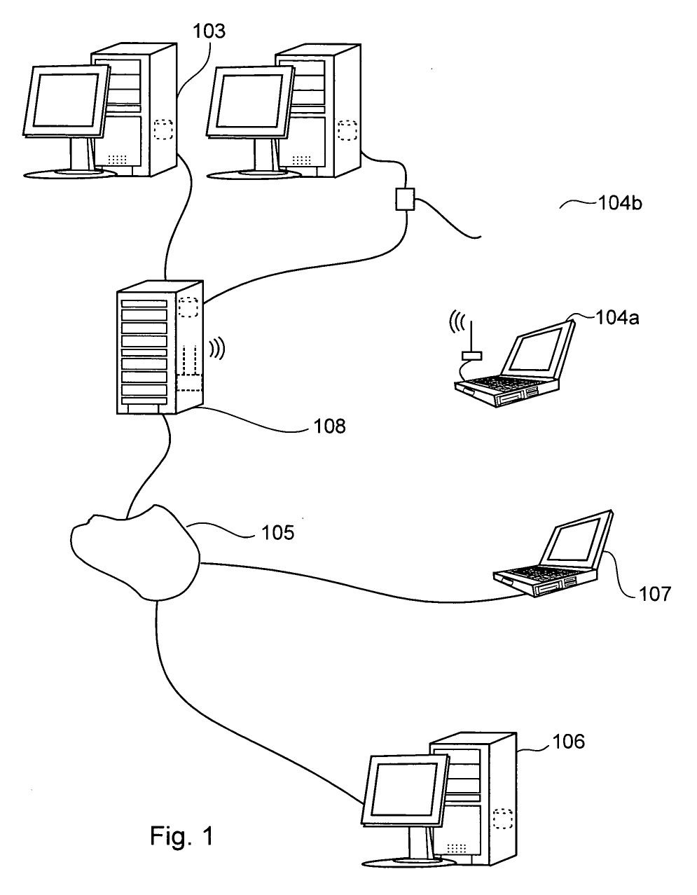

Referring to FIG. 1, a prior art network 100 is shown. The network 100 includes a file server 101 having a network connection and a hard disc drive 108 for storing files. Additionally, a desktop computer 103 is in electrical data communication with the file server 101 and a laptop computer 104a is connected to the file server 101 using a wireless link. Other laptop computers 104b use a conventional data cable to connect to the file server 101. The file server is also in data communication with the Internet 105 thereby allowing access to files on the file server to other desktop computers 106 and laptop computers 107 supporting an Internet connection. A user of the laptop computers 104a, 104b or a desktop computer 103 will typically load a file from the hard disc drive 108 of the file server 101 onto the computer, work on the file and save it back to the hard disc drive 108 of the file server 101. This allows everyone with access to the server to store files in a central location.

Clearly, if the user wishes to work on a file that is stored on the network 100 but not stored on the laptop computer 104 then the user will attempt to access the file from the network 100. If the network 100 is not accessible by the laptop computer 104 then the user will typically wait until the network 100 is accessible. When the network 100 is accessible, the file is downloaded to the laptop computer 104 where the user reviews the file and optionally makes changes to it. If the user has made changes then it is normal procedure to save the changed file back to the network 100. Unfortunately, people are often forgetful and consequently, it is not uncommon that a user may wish to work on a file from their laptop computer in a location that does not support a communication link with the network 100. Additionally, the user might modify a network file, save the new version of the file to a hard disc drive of the laptop and forget to save it back to the network 100 when the network connection is established. These problems result in confusion and poor productivity. Clearly, various other configurations of prior art file servers are known. The file server described with reference to FIG. 1 is meant to be generic.

In order to ensure that the data stored on a file server is safe, it is periodically backed up. Typically, backing up the data involves taking the server offline and copying the files stored on the file server to another storage system. This represents a problem in that the computers that rely on the file server for storing files are unable to access files from the file server while the file server is offline. One option to overcome this problem involves maintaining a second file server which holds a redundant copy of the files stored in the hard disc drive 108 of the file server 101. Such a redundant server, also referred to as a mirror, will immediately copy any file on the file server 101 when changes are made. Clearly, maintaining a redundant server is wasteful however; it is justifiable if the file server 101 is needed continuously.

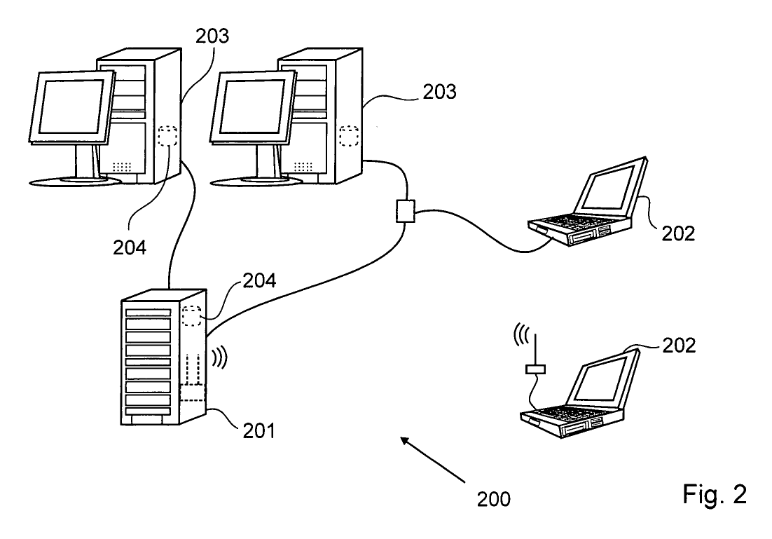

The network architecture according to the invention takes advantage of the equipment that is provided with almost all desktop computers and laptop computers. Specifically, these devices are typically provided with very large hard disc drives. Indeed, in the last decade the data storage capacity of a typical desktop computer hard disc drive has increased by a factor of roughly one thousand times. Despite improvements in access time and storage capacity of hard disc drives, the file server network architecture as described with reference to FIG. 1 has remained standard. Unlike the file server architecture described with reference to FIG. 1, the first embodiment of the invention shown by the inventive network architecture described with reference to FIG. 2 relies on the storage of files on the computers of the individuals who have authorization to use those files. Specifically, network storage files are associated with the computers of specific users who are authorized to have access to those files. For example, a mechanical design group would have access to specific network storage design files but they would not have access to, for example, the network storage files associated with an accounting group.

It should be noted that there are some prior art file server and network architectures that support file distribution. One such system is present in U.S. Pat. No. 6,742,028 by Wang et al., filed 15 Sep. 2000 (Wang). The system according to Wang is designed to automatically configure computers that support data communication with the network in a predetermined fashion. Specifically, a computer, newly attached to the network of Wang will receive a new operating system and other software assuming such software is not already installed. More importantly, the system according to Wang supports backing up data to a central server. The backing up operation relies on a file server in the network of Wang transmitting a content map. The content map is sent to all computers connected to the network. The content map lists all of the files available on the network as well as a hash value for each file. When a file associated with a specific computer and indicated on the content map has hash values that do not match the hash value of the file on the server, the file is copied from the file server to the machine having the unmatched files. This backing up procedure is optionally carried out according to a schedule. Unlike the system described with reference to FIG. 2, the system according to Wang maintains a copy of every file on a central server.

Referring to FIG. 2, an embodiment of the invention in the form of a network architecture is shown. The network 200 includes an enterprise cloned drive (ECD) server 201, laptop computers 202 and desktop computers 203. Each of the laptop computers 202 and the desktop computers 203 is equipped with at least one non-volatile storage medium, in this case the medium is a hard disc drive 204. The ECD server 201 is notified when a client computer is newly connected to the network. The ECD server 201 is also notified when a client computer connected to the network saves a network storage file. Further, the ECD server 201 is notified when a client computer that has saved a new version of a network storage file while not in data communication with the ECD server 201 establishes data communication with the ECD server 201.

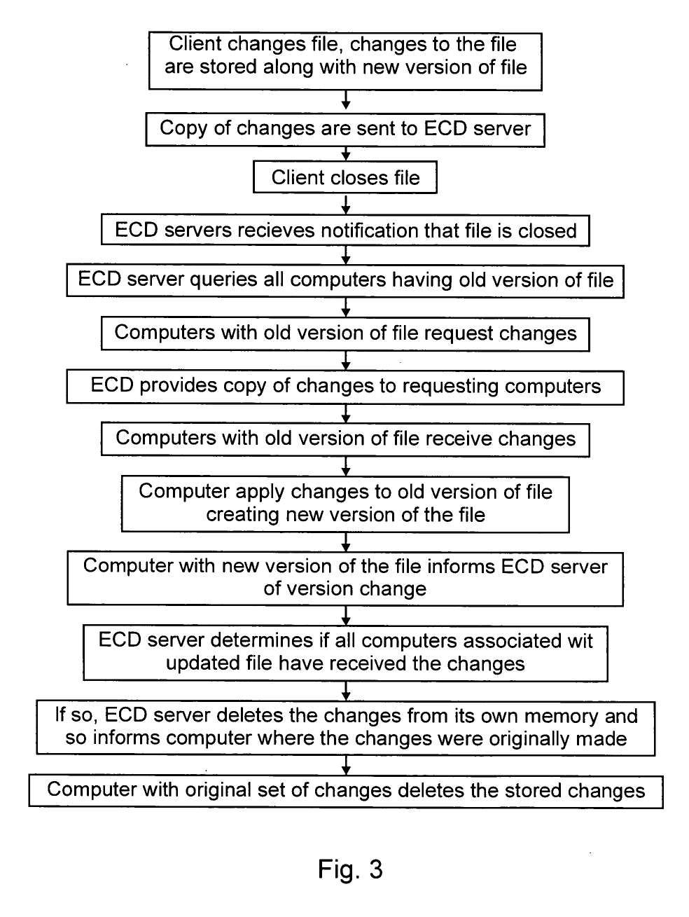

Referring to FIG. 3, a flowchart describing the processes associated with saving a network storage file in a system according to the first embodiment of the invention is shown. When a network storage file is saved it is stored on the hard disc drive of the computer that saved it along with a changes file that stores all of the changes that have been made from the previous version of the network storage file to the saved version. The changes file is generated by client software on the client computers, both laptop computer 202 and desktop computer 203, associated with the ECD server 201. The ECD server 201 receives a notification regarding the saving of the network storage file and queries the client computer to automatically copy the changes file to a storage medium of the ECD server 201. The ECD server 201 then queries other client computers that are authorized to maintain a copy of the network storage file. The authorized client computers that are in communication with the ECD server 201 then request a copy of the changes file. These client computers use the changes file to modify their copy of the network storage file thereby generating the new version of the network storage file. If a client computer that normally maintains a copy of the network storage file is not accessible then the ECD server 201 maintains a copy of the changes file and queries the client computers authorized to have the network storage file when those client computers are once again in communication with the network. Thus, the ECD server 201 keeps a copy of the changes file until all client computers that normally maintain a copy of the network storage file receive the changes file. Similarly, in the event that a client computer saves a network storage file when that client computer has no access to the ECD server 201 then the ECD server 201 will be notified of the saving of the network storage file when the client computer is in data communication with the ECD server 201. Similarly the client computer that made the changes will also store an associated changes file and, preferrably, maintain a copy of the changes file until the ECD server 201 notifies the client computer that all of the client computers authorized to maintain a copy of the network storage file have applied the changes file. A person of skill in the art will appreciate that a wide variety of modifications to the method described with reference to the flowchart FIG. 3 are easily contemplated without departing from the spirit and scope of the invention. For example, the first client computer optionally provides the changes file to the ECD server absent a data transfer from the ECD server indicating that it is ready to receive the changes file. In this case, the sending client computer, having sent the changes file, will wait for confirmation that the file was sent successfully and, absent such confirmation, send the changes file again based upon any of a wide variety of criteria such as, for example: time, user priority, and network status.

In situations in which a high bandwidth data transfer communications link exists between the ECD server 201 and the client computers it is suggested that the network storage files be updated promptly. In other circumstances, it will be preferable to not update the network storage files until a more suitable network connection is established. Thus, a user having a plurality of network storage files on a laptop computer 202 who chooses to access their company computer network using a low bandwidth telephone connection need not update their network storage files. Optionally, such a user having modified a single network file will choose to inform the ECD server 201 of the existence of the new version of the network storage file and proceed to upload the corresponding changes file. Further optionally, as changes are made to a network storage file on a client computer a series of changes files are provided to the ECD server 201 as changes to the network storage file are saved. Thus, if a user is modifying a network storage file using a word processor and saving the network storage file at regular intervals then changes files indicative of each set of changes to the network storage file made between each instance of saving the network storage file are optionally uploaded to the ECD server 201 as these changes files are generated. This is advantageous because it not only provides a secondary storage medium containing all of the most recent changes to the network storage file, but it also reduces the need for a high bandwidth data connection between the client computer and the ECD server 201 because the changes are being uploaded soon after they occur, instead of all of the changes being incorporated in one changes file that is sent when the word processing program is shut down. Clearly, a person of skill in the art will appreciate that a system according to the invention will support a variety of different computer programs and not merely word processors.

If different users try to modify a network storage file simultaneously, the ECD system will act to prevent conflicts associated with different versions of the same network storage file. Specifically, one way to prevent such conflicts comprises having the ECD server lock the network storage file and only the first user who opened the network storage file for writing, has the permission to write the new version of the network storage file and store the changes file while others are only permitted read the network storage file from their local storage. Clearly, while the lock is enabled, other users are permitted to open the network storage file, modify it and save it along with a changes file provided the network storage file and changes file are provided names that are different from the names of the original network storage file and a changes file for the original network storage file. Such a lock is optionally applied to a byte range of the network storage file or the whole network storage file. Additionally, if a user modifies a network storage file while their computer is not in data communication with the ECD sever 201 and the original network storage file has been modified then the ECD sever 201 will optionally carry out the operations to update the network storage file based on predetermined criteria, such as user priorities and the time of, for example, opening or modification when data communication with the ECD sever 201 is established. Optionally, the modified network storage file is stored as a new version along with an associated changes file along with an indicator indicative of at least one of: the user who changed the file, time of the change and, revision number. This will facilitate a user comparing two different files and further modifying the updated network storage file.

In the event that a user is unable to save a file on the hard disc drive of a client computer due to a lack of storage capacity, the hard disc drive is optionally scanned for infrequently used files. Further optionally, when a sufficient number of infrequently used network storage files are identified, they are truncated to smaller size from the hard disc drive of the user's computer thereby providing storage space for the updated network storage file. Further optionally, prior to truncating a given infrequently used file, the ECD server will query other computers to ensure that at least one copy of the given infrequently used file is present on a storage medium of at least one other computing device in an other than truncated state. In this case, if the user is unable to save a user file due to a local storage capacity constraint and the ECD server 201 is not accessible to the client computer then an error message associated with an inability to save the given file will be provided and no files will be truncated. When the user tries to open a network storage file from the truncated infrequently user files, an other than truncated version of the network storage file is retrieved from one another client computer by informing the ECD server 201 and requesting the network storage file. If there is no a connection to the ECD server 201 an error message informs the end user that the desired network storage file is not currently available. Optionally, if the client computer making the unsuccessful request for the truncated network storage file is in data communication with the ECD server 201 then the ECD server 201 stores data associated with the failed request, the data comprising the identity of the client computer that made the request for the other than truncated version of the network storage file. When another client computer having an other than truncated version of the requested network storage file establishes data communication with the ECD server 201, the ECD server 201 requests a copy of desired network storage file. Once the request is approved, the client computer provides a copy the desired file to a storage medium of the ECD server 201. The ECD server 201 then queries the client computer which has the truncated version of the network storage file and, in so doing, informs the client computer that the other than truncated version of the file is available. The client computer with the truncated version of the file verifies that it has sufficient storage capacity to receive the other than truncated version of the network storage file. Assuming that there is sufficient storage capacity to receive the other than truncated version of the network storage file, the client computer optionally approves transfer of the other than truncated version of the network storage file from the ECD server 201 to the client computer. Optionally, the client computer is scanned for predetermined low priority files instead of infrequently used files. A person of skill in the art will appreciate that a wide variety of criteria are optionally used to determine which files have low priority and most suitable for being truncated.

In the system according to the first embodiment of the invention, the ECD server 201 maintains a master directory indicative of which computers maintain a copy of specific network storage files. This system is highly beneficial as it helps to support recovery of a client computer associated with the ECD server 201 after a catastrophic failure of the storage media, usually a hard disc drive, that it uses for storing files on the client computer. Specifically, since the ECD server 201 maintains a directory of which network files are associated with each client computer, it is a simple matter to determine which network storage files should be copied to a new storage medium of the client computer and which client computers have suitable versions of those network storage files. Thus, it is a simple matter to copy the desired network storage files from other client computers associated with the ECD server 201 to the client computer where they are needed. A copy of the directory of network storage files for each client computer is also stored on the respective client computer.

In the event that the storage media of the ECD server 201 should suffer a catastrophic failure, a working storage media is provided to the ECD server 201. ECD server software then instructs the ECD server 201 to query the client computers in communication with the ECD server 201. The ECD server 201 requests copies of the directory file which lists the networks storage files on the associated client computers. Using the directory files, the ECD server 201 is able to reconstruct the master directory.

The ECD network architecture described with reference to the first embodiment of the invention is highly advantageous in comparison with prior art networks for a variety of reasons. For example, files that would be stored on a network in a prior art system will typically load faster from a hard disc drive than they do over a network. Consequently, when a user opens a network storage file, the loading of the network storage file is not typically constrained by the speed of the network, available data bandwidth over the network or the availability of a server. This reduces the need for network resources thereby enhancing available bandwidth in the network for other network operations. Additionally, when a user connects their client computer to a network according to the first embodiment of the invention at regular and frequent intervals then their client computer will always have recent copies of all the network storage files associated with the work that they do, even for network storage files that they have not personally worked on. Further, in typical operation, the networks associated with the first embodiment of the invention need only transfer file data when a network storage file is changed. Consequently, network resources are not used when, for example, a user scans a file but does not make changes. Additionally, since the network is typically transferring changes files instead of entire files it is likely that data traffic over the network is substantially reduced. Another advantage is that users only have access to those network storage files that they would normally be authorized to have a copy of. Those network storage files that the user is not authorized to access are not available to them. This simplifies a variety of security issues. Further, the ECD servers according to the first embodiment of the invention do not typically maintain copies of the network storage files. Consequently, a hacker who gains access to the ECD server does not have direct access to the network storage files. Another critical advantage of the system according to the first embodiment of the invention is that file updates for network storage files are handled automatically, the user need not remember to update files on the file server. When the user saves a network storage file the system will act to save another copy of the file to another client computer automatically. Thus, in the system according to the first embodiment of the invention, users cannot mistakenly save a network storage file to a storage medium on their computer and neglect to save the file to the network. The system according to the first embodiment of the invention helps to ensure that only one version of given network storage file is available at any given time on each authorized client computer, thereby avoiding confusion regarding multiple version of the same file.

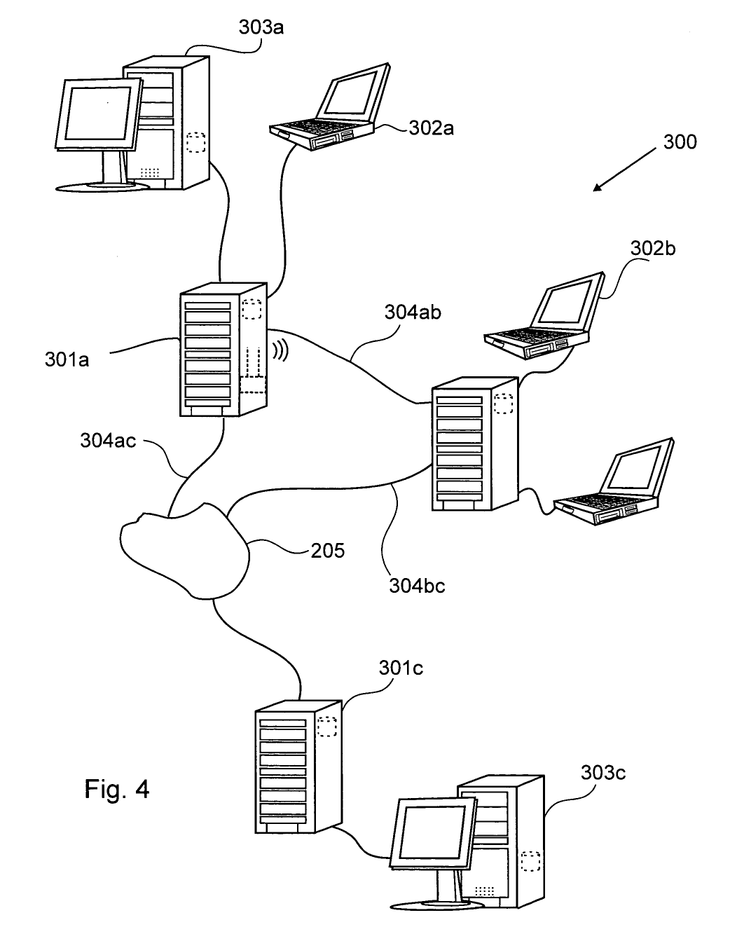

Referring to FIG. 4, a second embodiment of the invention featuring a large network supporting a set of ECD servers is shown. The network 300 includes ECD servers 301a, 301b and 301c. Each of these ECD servers 301a, 301b and 301c supports a set of client computers as described with reference to FIG. 2. Additionally, the ECD servers 301a to 301c support data links 304ab, 304ac and 304bc that facilitate the transfer of data between the ECD servers 301a to 301c. Also shown are, a laptop computer 302a and a desktop computer 303a in data communication with the first ECD server 301 a, a laptop computer 302b in data communication with the second ECD server 301b and a desktop computer 303c in data communication with the third ECD server 301c.

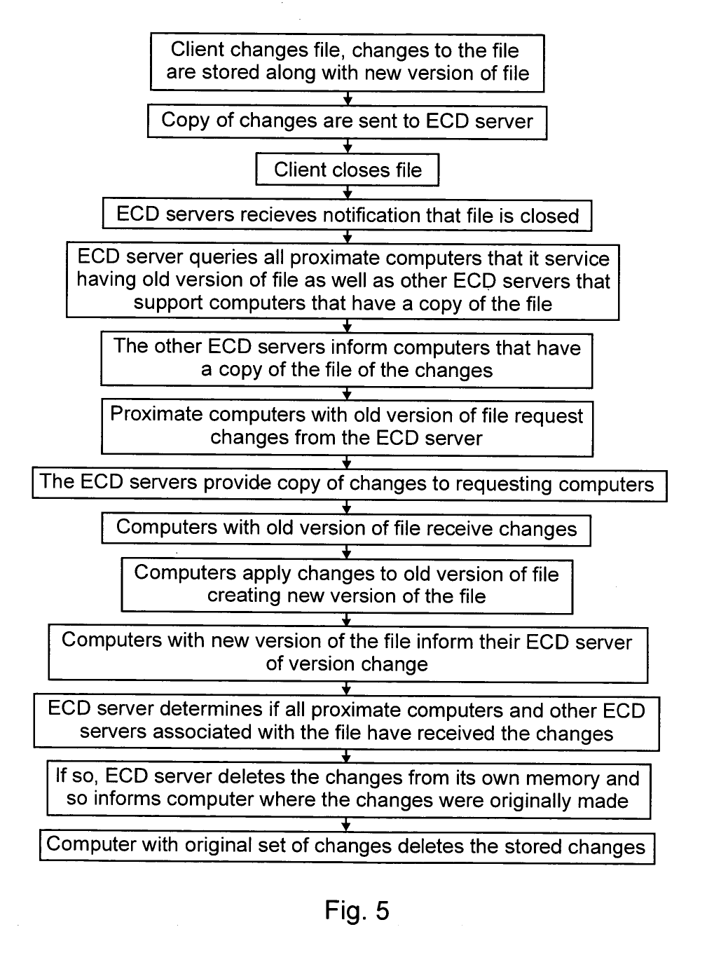

Referring to FIG. 5, a flowchart describing the processes associated with saving a network storage file in a system according to the second embodiment of the invention is shown. When a network storage file is saved it is stored on the hard disc drive of the client computer that saved it along with a changes file that stores all of the changes that have been made from the previous version of the network storage file to the saved version. The changes file is generated by client software on the client computer associated with the ECD server 301a. The ECD server 301a receives a notification regarding the saving of the network storage file and queries the client computer to automatically copy the changes file to a storage medium of the ECD server 301a. The ECD server 301a then queries other client computers that are authorized to maintain a copy of the network storage file in addition to other ECD servers 301b and 301c if those ECD servers support other client computers that are authorized to have a copy of the network storage file. The client computers that are in communication with the ECD server 301a then request a copy of the changes file. Similarly, client computers supported by ECD servers 301b and 301c request copies of the changes file. These client computers use the changes file to modify their copy of the network storage file. If a client computer that normally maintains a copy of the network storage file is not accessible then the ECD server that supports the inaccessible client computer maintains a copy of the changes file and queries the client computers authorized to have the network storage file when those client computers are once again in communication with the ECD server. Thus, the ECD server 301a keeps a copy of the changes file until all client computers proximate ECD server 301a that normally maintain a copy of the network storage file apply the changes file. Similarly, in the event that a client computer saves a network storage file when that client computer has no access to the ECD server 301a then the ECD server 301a will be notified of the saving of the network storage file when the client computer is in data communication with the ECD server 301a. Similarly the client computer that made the changes will also store an associated changes file and, optionally, maintain a copy of the changes file until the ECD server 301a notifies the client computer that all of the client computers authorized to maintain a copy of the network storage file have applied the changes file.

In use, a user modifies a network storage file on, for example the laptop computer 302a. When the network storage file is stored on a non-volatile storage medium of the laptop computer 302a, a changes file indicative of all of the changes to the network storage is saved and ECD server 301a is notified. ECD server 301a requests a copy of the changes file and provides a copy of the changes file to other client computers authorized to have a copy of the network storage file. In this case, the desktop computer 303a is authorized to have a copy of the network storage file. The desktop computer 303a receives a changes file and saves the updated network storage file on an associated storage medium. ECD server 301a has a master directory file that indicates which client computer proximate ECD server 301a are authorized to the have a copy of the network storage file. Additionally, ECD sever 301a has a directory file that indicates which ECD servers proximate ECD server 301a are authorized to have copies of changes files associated with the network storage file. In dependence upon directory entries, the ECD server 301a also provides copies of the changes file the other ECD servers 301b and 301c. These ECD servers 301b and 301c then provide the updated network storage file to the computing devices authorized to maintain a copy of the network storage file. Those client computer proximate ECD server 301b that are authorized to have a copy of the network storage file will be listed in a master directory on ECD server 301b. These client computers then save the updated network storage files on an associated storage medium. In this case, those client computers are laptop computer 302b and desktop computer 303c. Typically, the associated storage medium would likely be a hard disc drive however this need not be the case.

The second embodiment of the invention is particularly well suited for organizations that have distributed facilities. Thus, a company having mechanical design groups in, for example, Denver, Albany and Dallas would optionally provide ECD servers for each design group. Thus, when a network storage file is saved in Denver, only one copy of the corresponding changes file is sent to Albany and Dallas. Clearly, the changes files are only sent to Albany and Dallas assuming that there are client computers authorized to store the corresponding network storage files in those areas. As shown in FIG. 3, ECD servers 301a and 301b have a dedicated data link 304ab that permits the transfer of data between ECD servers 301a and 301b absent data transfer over the Internet. Clearly, in the event that the data link 304ab is not useable, the ECD servers 301a and 301b optionally communicate via the Internet 205. ECD server 301c is coupled to ECD servers 301a and 301b via the Internet 205. As person of skill in the art will appreciate that a variety of encryption techniques exist in order to reduce the likelihood of files being intercepted by unauthorized third parties when the file are transferred over a public network, such as the Internet. A person of skill in the art will appreciate that there are a wide variety of ways to transfer data between ECD servers.

As a person of skill in the art of network design will be aware, the embodiment of FIG. 3 is intended to be illustrative of the invention and not limiting. Thus, in a more typical implementation of an ECD server network each ECD would support a large plurality of computing devices, each of the computing devices having a memory sufficient to store a large number of files. Additionally, an ECD network easily supports a large number of ECD servers and a variety of communication architectures are optionally employed to facilitate data communication between the ECD servers. For example, with a network according to the second embodiment of the invention using six ECD servers optionally connects the servers in a ring-architecture. Other variations would permit the ECD servers to communicate by means of dedicated a mesh network, while another variation relies exclusively on the Internet to move data between the ECD servers. Additionally, the ECD system is able to work with a variety of different file formats, and computing platforms. Clearly, the invention supports a variety of different computing devices, such as laptop computers, desktop computers, and personal digital assistants to describe a few. Further, although the embodiments of FIG. 2 and FIG. 4 use hard disc drives as a storage medium other storage mediums such as tape drives, optical drives, RAM, and high capacity flash cards with any type of file system that provides generic files to applications, are also useable. That said, hard disc drives represent a superb storage medium for a network according to the invention due to their low cost, high speed, large storage capacity and their presence in most personal computing devices. As will be apparent to one of skill in the art, the client computers optionally communicate with their associated ECD server via an Internet data connection.

The ECD network architecture described with reference to the second embodiment of the invention is highly advantageous in comparison with prior art networks for a variety of reasons. Files that would be stored on a network in a prior art system will typically load faster from a hard disc drive than they do over a network. Consequently, when a user opens a network storage file, the loading of the network storage file is not typically constrained by the speed of the network or available data bandwidth over the network. This reduces the need for network resources thereby enhancing available bandwidth in the network for other network operations. Additionally, when a user connects their client computer to a network according to the second embodiment of the invention at regular and frequent intervals then their client computer will always have recent copies of all the network storage files associated with the work that they do, even for network storage files that they have not personally worked on. Further, in typical operation, the networks associated with the second embodiment of the invention need only transfer file data when a network storage file is changed. Consequently, network resources are not used when, for example, a user scans a file but does not make changes. Additionally, since the network is typically transferring changes files instead of entire files it is likely that data traffic over the network is substantially reduced. Another advantage is that users only have access to those network storage files that they would normally be authorized to have a copy of. Similarly, users have access to network storage files associated with other users who are geographically distant. Those network storage files that the user is not authorized to access are not available to them. This simplifies a variety of security issues. Further, the ECD servers according to the second embodiment of the invention do not typically maintain copies of the network storage files. Consequently, a hacker who gains access to the ECD server does not have direct access to the network storage files. Another critical advantage of the system according to the second embodiment of the invention is that file updates for network storage files are handled automatically, the user need not remember to update files on the file server. When the user saves a network storage file the system will act to save at least one other copy of the file to another client computer automatically, regardless of where the client computers are located. Thus, users cannot mistakenly save a network storage file to only one of a storage medium on their computer and their network while forgetting to save to the other medium. The system according to the second embodiment of the invention also helps to ensure that only one version of given network storage file is available at any given time.

In the system according to the second embodiment of the invention, the ECD server 301a maintains a master directory indicative of which client computers proximate ECD server 301a maintain a copy of specific network storage files. Additionally, ECD server 301a maintains a directory file indicative of which other ECD servers have client computers that are proximate the given other ECD server that maintain a copy of a given network storage file. This system is highly beneficial as it helps to support recovery of a client computer associated with the ECD server 301a after a catastrophic failure of the storage media, usually a hard disc drive, that it uses for storing files on the client computer. Specifically, since the ECD server 301a maintains a directory of which network files are associated with each client computer that is proximate to ECD server 301a, it is a simple matter to determine which network storage files should be copied to a new storage medium of the client computer and which client computers and, if it is deemed necessary, other ECD servers 301b and 301c are able to access current versions of those network storage files. Thus, it is a simple matter to copy the desired network storage files from other client computers associated with the ECD server 301a to the client computer where they are needed. A copy of the directory of network storage files for each client computer is also stored on the respective client computer.

In the event that the storage media of the ECD server 301a should suffer a catastrophic failure, a working storage media is provided to the ECD server 301a. ECD server software running on the ECD server 301a then queries client computers and other ECD servers 301b and 301c in communication with the ECD server 301a. The ECD server 301a query comprises a request for copies of directory files that list the network storage files on the associated client computers as well as other ECD servers that are proximate the ECD server 301a. More specifically, the ECD server 301a need not maintain a directory file indicative of which client computers serviced by other ECD servers maintain a copy of a network storage file. However, ECD server 301a stores data indicative of whether any of the client computers associated with a given other ECD server 301b or 301c maintain a copy of given network storage file. Thus, ECD server 301b maintains a directory file indicative of the presence of any client computers proximate ECD server 301a that maintains a copy of a network storage file that is also maintained by a client computer proximate ECD server 301b. However, ECD server 301b need not maintain a record indicative of which client computers, or how many client computers, proximate ECD server 301a actually maintain a copy of the network storage file. Using the directory files, the ECD server 301a is able to reconstruct the master directory.

The system according to the invention supports version tracking simply and easily. A person of skill in the art will appreciate that the file system according to the invention is susceptible to malicious modification to critical network storage files. Specifically, a malicious user having gained access to a client computer having network storage files may modify the network storage file resulting in a loss of critical data. When the network storage file is saved, these changes would then propagate to other client computers as described with reference to the first and second embodiments of the invention. In order to ensure that such damage is minimized, a version tracking system is optionally associated with a client computer. The version tracking system maintains a copy of a baseline version of a network storage file. When the client computer modifies this version of the network storage file, the changes file is stored by the version tracking system. Unlike an ECD client computer, the changes file need not be used to modify the baseline version of the network storage file. Subsequent additional changes to the network storage file result in producing new changes files that are also stored by the version tracking system. When a specific version of the network storage file is desired it is a simple matter for an authorized user to gain access to the version tracking system and produce any version of the network storage file since the baseline version. Clearly, one network storage file optionally supports more than one baseline version. Thus, if a new baseline version is generated for every ten changes then only ten changes files need to be applied to any given baseline file to generate the desired version of the network storage file. Clearly, the generation of a new baseline file is optionally triggered by any one of a variety of criteria, not necessarily as a result of a number of new versions to a network storage file. Thus, a new baseline file is optionally generated at a specific time interval, such as at the end of every month. It will also be apparent to a person of skill in the art that the generation of a specific version of a network storage file using such a version tracking system is supported remotely within the ECD network system. Thus, a user of another client computer optionally downloads a baseline network storage file and a set of changes files from another client computer.

Numerous other embodiments of the invention will be apparent to one of skill in the art without departing from the spirit and the scope of the invention. For example, while it is believed that saving and distributing changes files is more efficient that saving entire network storage files, it will be apparent to one of skill in the art that a variation of the system according to either of the first and second embodiments of the invention supports the storage and distribution of entire files instead of change files. Further optionally, network storage files have specific attributes that render them accessible only to the ECD server when they are stored on a client computer other than a specific client computer. Thus, a user is able to create a copy of a secure file and recover the secure file without another user having access to that document even though the another user has the secure file stored on their computer.

What is claimed is:

1. A method of storing an electronic data file comprising:
providing a first computing device other than a file server and comprising a first associated storage medium;
providing a second computing device other than a mirror of the first computing device and comprising a second associated storage medium and in communication with the first computing device;
providing a server;
establishing a first data transfer path from the first computer device to the server;
establishing a second data transfer path from the server to the second computing device;
storing a first file on the first computing device within the first associated storage medium;
storing the first file on the second computing device within the second associated storage device;
modifying the first file on the first computing device to form a new version of the first file;
storing the new version of the first file on the first associated storage medium;
transferring at least a change instruction from the first computing device to the second computing device via the server, the at least a change instruction comprising data for, in combination with the first file, generating the new version of the first file; and,
automatically storing the new version of the first file within the second associated storage medium by applying the at least a change instruction to the first file.

2. A method of storing an electronic data file according to claim 1, comprising:
providing a third computing device other than a mirror of the first or second computing devices and comprising a third associated storage medium and in communication with the first computing device;
storing the first file on the third computing device within the third associated storage medium;
automatically storing the new version of the first file within the third associated storage medium.

3. A method of storing an electronic data file according to claim 1, wherein there is no a direct communication link between the first and second computing devices.

4. A method of storing an electronic data file according to claim 1, wherein in providing the first computing device the associated storage medium is a hard disc drive.

5. A method of storing an electronic data file according to claim 4, wherein in providing the first computing device the first computing device is a portable computer.

6. A method of storing an electronic data file according to claim 5, wherein in providing a second computing device the first computing device communicates with the second computing device via the Internet.

7. A method of storing an electronic data file according to claim 2, wherein in providing the first computing device the associated storage medium is a hard disc drive.

8. A method of storing an electronic data file according to claim 7, wherein in providing the first computing device the first computing device is a portable computer.

9. A method of storing an electronic data file according to claim 7, additionally comprising:
loading the new version of the first file onto the second computing device;
modifying the new version of the first file on the second computing device;
storing the modified version of the file on the storage medium associated with the second computing device;
automatically storing the modified version of the first file within the first associated storage medium; and,
automatically storing the modified version of the first file within the third associated storage medium.

10. A method of storing an electronic data file according to claim 2, comprising providing a fourth computing device having a memory, wherein automatically storing the new version of the first file within the second associated storage device comprises:
storing the at least a change instruction to the new version of the first file to the memory of the fourth computing device;
storing the at least a change instruction provided from the memory of the fourth computing device to the second associated storage device;
applying the at least a change instruction to the first file to generate the new version of the first file; and,
storing the new version of the first file to the second associated storage device.

11. A method of storing an electronic data file according to claim 10, comprising: upon successfully storing the new version of the first file on the second associated storage device, erasing the at least a change instruction from the memory of the fourth computing device.

12. A method of storing an electronic data file according to claim 10, comprising:
providing a fifth computing device having a memory,
wherein storing a copy of the new version of the first file to the second associated storage device comprises:
providing a copy of the at least a change instruction from the memory of the fourth computing device to the memory of the fifth computing device;
storing a copy of the at least a change instruction provided from the memory of the fifth computing device to the second computing device;
applying the at least a change instruction to the first file to generate the new version of the first file; and,
storing the new version of the first file to the second associated storage device.

13. A method of storing an electronic data file according to claim 12, comprising: upon successful storing of the new version of the first file on second associated storage device, deleting the copy of the change instructions to the first file from the memory of the fifth computing device.

14. A method of storing an electronic data file according to claim 12, wherein providing a copy of the changes to the first file from the memory of the fourth computing device to the memory of the fifth computing device the at least a change instruction is transferred via the Internet.

15. A method of storing an electronic data file according to claim 1, wherein storing a first file on the first computing device within the first associated storage medium comprises:
determining that the first associated storage medium has insufficient data storage capacity to store the first file;
scanning the first associated storage medium for infrequently used files;
truncating at least a file of the infrequently used files, the truncating of the at least a file of the infrequently used files for providing sufficient data storage capacity to store the first file; and
storing the first file on the first associated storage medium.

16. A method of storing an electronic data file according to claim 15, wherein providing the first computing device the associated storage medium is a hard disc drive.

17. A method of storing an electronic data file according to claim 16, wherein providing the first computing device the first computing device is a portable computer.

18. A method of storing an electronic data file according to claim 17, wherein providing a second computing device the first computing device communicates with the second computing device via the Internet.

19. A method of storing an electronic data file according to claim 17, additionally comprising:
loading the new version of the first file onto the second computing device;
modifying the new version of the first file on the second computing device;
storing the modified version of the file on the storage medium associated with the second computing device;
automatically storing the modified version of the first file within the first associated storage medium; and,
automatically storing the modified version of the first file within the third associated storage medium.

20. A portable computing device comprising:
a processor for updating a file and storing an updated file associated with the file;
a communication port for supporting electronic communication with an enterprise cloned drive server; and,
a non-volatile storage medium, the non-volatile storage medium for storing files, the non-volatile medium for containing instructions for:
associating an act of storing the updated file with at least a workgroup related to the updated file;
upon successful association of an updated file with a workgroup,
automatically contacting an enterprise cloned drive server via the communication port;
automatically providing data relating to the updated file to the communication port, the data for being stored in a storage medium of a first other computing device and a storage medium of a second other computing device, the first and second other computing devices being other than mirrored to the portable computing device.

21. A portable computing device according to claim 20, wherein the non-volatile storage medium is a hard disc drive.
